(19) United States
(12) Patent Application Publication
(10) Pub. No.: US 2006/0216486 A1
(43) Pub. Date: Sep. 28, 2006

(54) Entry board suitable for use during drilling of an integrated circuit board

(75) Inventor: Fuh-Shyong Chen, Hsin-Chu Hsien (TW)

Correspondence Address: OSTROLENK FABER GERB & SOFFEN, 1180 AVENUE OF THE AMERICAS, NEW YORK, NY, 100368403, US

(73) Assignee: Te-Han Wang

(21) Appl. No.: 11/222,586

(22) Filed: Sep. 9, 2005

(30) Foreign Application Priority Data
Mar. 28, 2005 (TW) 094204768

(51) Int. Cl. B32B 27/38; B32B 27/36; B32B 27/30; B32B 27/04; B32B 7/02

(52) U.S. Cl. 428/212; 428/522; 428/482; 428/413; 428/537.5

(57) ABSTRACT

An entry board suitable for use during drilling of an integrated circuit board includes a main laminated structure sequentially formed with a base layer made from wood fibers, a reinforcing layer of a thermosetting resin, and a hard layer of a UV-cured resin. The laminated structure further includes a coating layer interposed between the base layer and the reinforcing layer, or a paper layer interposed between the reinforcing layer and the hard layer. The coating layer or paper layer has a color different from that of the base layer.

### BACKGROUND OF THE INVENTION

1. Field of the Invention

This invention relates to an entry board suitable for use during drilling of an integrated circuit board, more particularly to an entry board having a laminated structure formed with a base layer, a reinforcing layer of a thermosetting resin, a hard layer of a UV-cured resin, and a coating layer or a paper layer having a color different from that of the base layer.

2. Description of the Related Art

When a printed circuit board (PCB) on a carrier is drilled by a drilling tool, an entry board is required to underlie the PCB so as to prevent the working surface of the carrier from being damaged by the drilling tool. One type of conventional entry boards is a plate of phenolics (also termed bakelite), which is made by heating and pressing wood pulp papers that have been impregnated with phenolics. Since the economic value of recycling the plate of phenolics is relatively low, the waste plate of phenolics is generally burned to ashes for landfill use. In addition, during burning treatment of the plate of phenolics, toxic gases, such as dioxins, are released. Hence, environmental concerns are incurred.

Another type of the conventional entry boards is a high density fiber board. Although the high density fiber board is safe for the environment, it requires complicated processing steps and treatments, such as continuous pressing under high temperature and high pressure, cutting and grinding, so as to meet density and thickness requirements for the entry board of this kind. Hence, while the production cost of the high density fiber board is relatively high, its productivity is relatively low.

In addition, surface hardness of the abovementioned entry boards is not sufficient. When the drilling tool reaches one of the abovementioned entry boards, burrs will be produced at peripheral edges of holes formed in the entry board, and surface smoothness of the entry board will be damaged. Furthermore, since each of the abovementioned entry boards exhibits only one color in its entire structure, position accuracy of holes relative to the carrier during the drilling operation cannot be easily determined.

### SUMMARY OF THE INVENTION

Therefore, the object of the present invention is to provide an entry board that is clear of the aforesaid drawbacks of the prior art.

According to one aspect of this invention, an entry board suitable for use during drilling of an integrated circuit board includes a base layer made from wood fibers, a coating layer formed on the base layer and having a color different from that of the base layer, a reinforcing layer of a thermosetting resin formed on the coating layer, and a hard layer of a UV-cured resin formed on the reinforcing layer.

According to another aspect of this invention, an entry board suitable for use during drilling of an integrated circuit board includes a base layer made from wood fibers, a reinforcing layer of a thermosetting resin formed on the base layer, a paper layer bonded to the reinforcing layer and having a color different from that of the base layer, and a hard layer of a UV-cured resin layer formed on the paper layer.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view to illustrate the first preferred embodiment of an entry board for an integrated circuit board according to this invention;

FIG. 2 is a fragmentary sectional view of the first preferred embodiment of this invention; and

FIG. 3 is a fragmentary sectional view of the second preferred embodiment of an entry board for an integrated circuit board according to this invention.

### DETAILED DESCRIPTION OF THE PREFERRED EMBODIMENTS

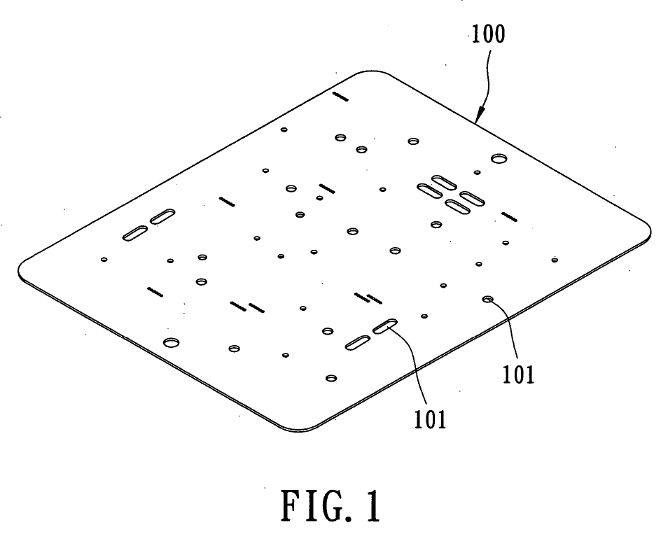

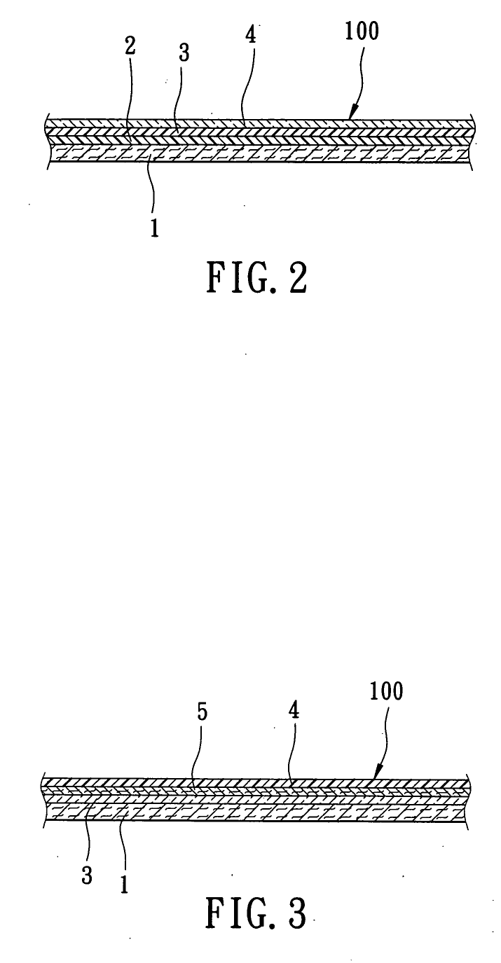

Referring to FIG. 1, the first preferred embodiment of an entry board 100 according to this invention is suitable for use during drilling of an integrated circuit board (not shown), and is formed with a plurality of through holes 101 having different sizes and shapes, such as circle and oval. Referring to FIG. 2, the first preferred embodiment of this invention includes a base layer 1, a coating layer 2 formed on the base layer 1, a reinforcing layer 3 formed on the coating layer 2, and a hard layer 4 formed on the reinforcing layer 3.

The base layer 1 is made from wood fibers, and is preferably made from medium density wood fibers. The coating layer 2 contains a pigment that has a color different that of the base layer 1, and that causes high contrast between the coating layer 2 and the base layer 1.

The reinforcing layer 3 is made from a thermosetting resin. Preferably, the reinforcing layer 3 is made from a transparent thermosetting resin. The thermosetting resin for forming the reinforcing layer 3 may be spread over the coating layer 2 by rolling or sprinkling techniques, and is bonded to the coating layer 2 when cured.

The hard layer 4 is made from a UV-cured resin. Preferably, the UV-cured resin is formed by curing a composition containing a UV-curable resin selected from the group consisting of UV-curable acrylic resins, UV-curable polyester resins, epoxy resins, epoxy modified acrylics, polyurea-formaldehyde modified acrylics, polyester modified acrylics, reactive acrylic monomers, and mixtures thereof, and an additive selected from the group consisting of photosensitizers, plasticizers, stabilizers, surfactants, fillers, and mixtures thereof. The composition that contains the UV-curable resin and the additive may be spread over the reinforcing layer 3 by rolling or sprinkling techniques, followed by subsequent irradiation using UV light. The UV light will initiate polymerization, cross-linking and grafting reactions of the composition, thereby curing the UV-curable resin in the composition to form the UV-cured resin, thus resulting in the hard layer 4 having a smooth surface on the reinforcing layer 3.

FIG. 3 illustrates the second preferred embodiment according to this invention. The second preferred embodiment is similar to the first preferred embodiment in the structure of the entry board 100 and compositions of the base layer 1, the reinforcing layer 3, and the hard layer 4, except that the coating layer 2 is replaced by a paper layer 5, and that the paper layer 5 is interposed between the reinforcing layer 3 and the hard layer 4.

The paper layer 5 has a surface that is coated with a pigment having the color different from that of the base layer 1, so as to cause high contrast between the paper layer 5 and the base layer 1, and that is bonded to the reinforcing layer 3.

According to this invention, since phenolics and high density fibers are not required in the manufacture of the entry board 100, the entry board 100 can be recycled without environmental problems, such as emission of toxic dioxins, and the complicated processing steps involved in producing high density fibers can be simplified or omitted. In addition, by virtue of the structure of the entry board 100 of this invention, surface hardness of the entry board 100, and bonding strength among the base layer 1, the coating layer 2, the reinforcing layer 3, and the hard layer 4, or among the base layer 1, the reinforcing layer 3, the paper layer 5, and the hard layer 4 can be improved. Hence formation of burrs at peripheral edges of holes in the entry board 100 during drilling of an integrated circuit board can be avoided. Besides, by virtue of the high contrast between the coating layer 2 or the paper layer 5 and the base layer 1, the position accuracy of holes relative to the carrier can be easily determined by operators when the entry board 100 underlies the integrated circuit board during drilling of the latter.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. An entry board suitable for use during drilling of an integrated circuit board, said entry board comprising:
a base layer made from wood fibers;
a coating layer formed on said base layer and having a color different from that of said base layer;
a reinforcing layer of a thermosetting resin formed on said coating layer; and
a hard layer of a UV-cured resin formed on said reinforcing layer.

2. The entry board of claim 1, wherein said reinforcing layer is transparent.

3. The entry board of claim 1, wherein said UV-cured resin is made from a composition comprising a UV-curable resin selected from the group consisting of UV-curable acrylic resins, UV-curable polyester resins, epoxy resins, epoxy modified acrylics, polyurea-formaldehyde modified acrylics, polyester modified acrylics, reactive acrylic monomers, and mixtures thereof, and an additive selected from the group consisting of photosensitizers, plasticizers, stabilizers, surfactants, fillers, and mixtures thereof.

4. An entry board suitable for use during drilling of an integrated circuit board, said entry board comprising:
a base layer made from wood fibers;
a reinforcing layer of a thermosetting resin formed on said base layer;
a paper layer bonded to said reinforcing layer and having a color different from that of said base layer; and
a hard layer of a UV-cured resin layer formed on said paper layer.

5. The entry board of claim 4, wherein said paper layer has a surface that is coated with a pigment having the color different from that of said base layer, and that is bonded to said reinforcing layer.

6. The entry board of claim 4, wherein said reinforcing layer is transparent.

7. The entry board of claim 4, wherein said UV-cured resin is made from a composition comprising a UV-curable resin selected from the group consisting of UV-curable acrylic resins, UV-curable polyester resins, epoxy resins, epoxy modified acrylics, polyurea-formaldehyde modified acrylics, polyester modified acrylics, reactive acrylic monomers, and mixtures thereof, and an additive selected from the group consisting of photosensitizers, plasticizers, stabilizers, surfactants, fillers, and mixtures thereof.
